(19) United States
(12) Patent Application Publication
(10) Pub. No.: US 2013/0050294 A1
(43) Pub. Date: Feb. 28, 2013

(54) Electronic Sun Shader For Perimeter Boards

(71) Applicant: Erik Hubo, Vliermaal (BE)

(72) Inventor: Erik Hubo, Vliermaal (BE)

(73) Assignee: MARTIN PROFESSIONAL A/S, Aarhus N. (DK)

(21) Appl. No.: 13/642,164

(22) PCT Filed: Apr. 18, 2011
(86) PCT No.: PCT/DK2011/050126

§ 371 Date: Oct. 19, 2012

(30) Foreign Application Priority Data
Apr. 22, 2010 (DK) PA 2010 00357

(51) Int. Cl. G09G 5/10

(52) U.S. Cl. 345/690

(57) ABSTRACT

The present invention relates to an electronic display system comprising:
a display comprising a number of display panels;
at display controller communicatively coupled to said display panels;
a content provider communicatively coupled to said display controller;
   where said display controller receives content to be displayed at said display, said display controller distributes and sends said content to said display panels in a predetermined manner characterized in that said electronic display system comprises a brightness controller communicatively coupled to said display controller and said content provider and in that said brightness controller is adapted to:
receive said content from said content provider,
adjust at least the brightness or the contrast of at least a part of said content based on a brightness signal,
send the adjusted content to said display controller.

### FIELD OF THE INVENTION

The present invention relates to an electronic display system comprising:
a display comprising a number of display panels;
at display controller communicatively coupled to said display panels;
a content provider communicatively coupled to said display controller;
   where said display controller receives content to be displayed at said display, said display controller distributes and sends said content to said display panels in a predetermined manner.

### BACKGROUND OF THE INVENTION

Nowadays more and more game stadiums (e.g. soccer stadiums) are replacing their cardboard advertisement by electronic perimeter boards. The advantage of these electronic perimeter boards is that they are real displays, and therefore very flexible in showing different advertisements, even moving advertisements. With the build-in LED technology they are very durable and able to operate outdoor.

In outdoor situations, direct contact with sunlight is inevitable. One advantage of the old cardboard advertisement boards is that they do not lose their contrast when placed in direct sunlight. The electronic perimeter boards, however, are very sensitive to this issue. If the light intensity of direct sunlight is too intense, the electronic perimeter boards seem to lose their initial contrast. As the dynamic range of television cameras is much lower than that of a human eye, cameras are even more sensitive to this issue. The consequence is often that it is impossible for the viewer to see the advertisement on the boards and this effect is furthermore increased in cases where the sport event is broadcasted as a TV signal. The result is that the TV viewer sees the perimeter board a one huge monotone surface without contrassurface which is very annoying. Another issue is than fact that advertiser typical pays for the amount of time where their advertisements were viewable on a TV screen. The result is that sports clubs selling the advertisement loses money amount of time where the advertisements are viewable is decreased. It is known that this can be solved by increasing the light intensity (i.e. brightness) of the perimeter boards affected by the direct sunlight.

However, a further very important aspect when working with electronic perimeter boards is that the spectator is in the illusion that the entire field is surrounded with one screen. In order to build this seamless screen out of several perimeter boards, the perimeter boards need to be color and brightness calibrated. In a setup with non-calibrated perimeter boards the different panels will become visible which decreases the esthetics look of the perimeter board.

Many perimeter board manufactures allow to change the brightness of a perimeter board using a switch. The brightness can be set to several predefined values. In order to keep the entire screen seamlessly, all the perimeter boards need to be switched in the same predefined value. This feature can also be used to anticipate to the direct sunlight. Perimeter boards that are in the direct sunlight are switched to a higher brightness level. This causes visible artifacts, e.g. hard edges, at the crossings between two perimeter boards with a different settings, losing the illusion of one seamless screen. Moreover, it is unlikely that these edges are at the same place as the direct sun light starts. Due to the nature of the predefined intervals of a switch it is unlikely that the chosen brightness compensation will be the one needed. These artifacts will be even more visible on videos captured by television cameras due to the low dynamic range of such a camera. Captured videos containing these artifacts are not suited for broadcast.

### DESCRIPTION OF THE INVENTION

The object of the present invention is to solve the problems described above. This can be achieved by the invention as defined by the independent claims and the benefits and advantages of the present invention are disclosed in the detailed description of the drawings illustrating the invention. The dependent claims describe possible embodiments of the present invention.

### DESCRIPTION OF THE DRAWING

FIG. 1 illustrates a perimeter board system according to prior art;

FIG. 2 illustrates a perimeter board system according to the present invention

FIG. 3 illustrates a transformation from one pixel space to another pixel space.

### DETAILED DESCRIPTION OF THE INVENTION

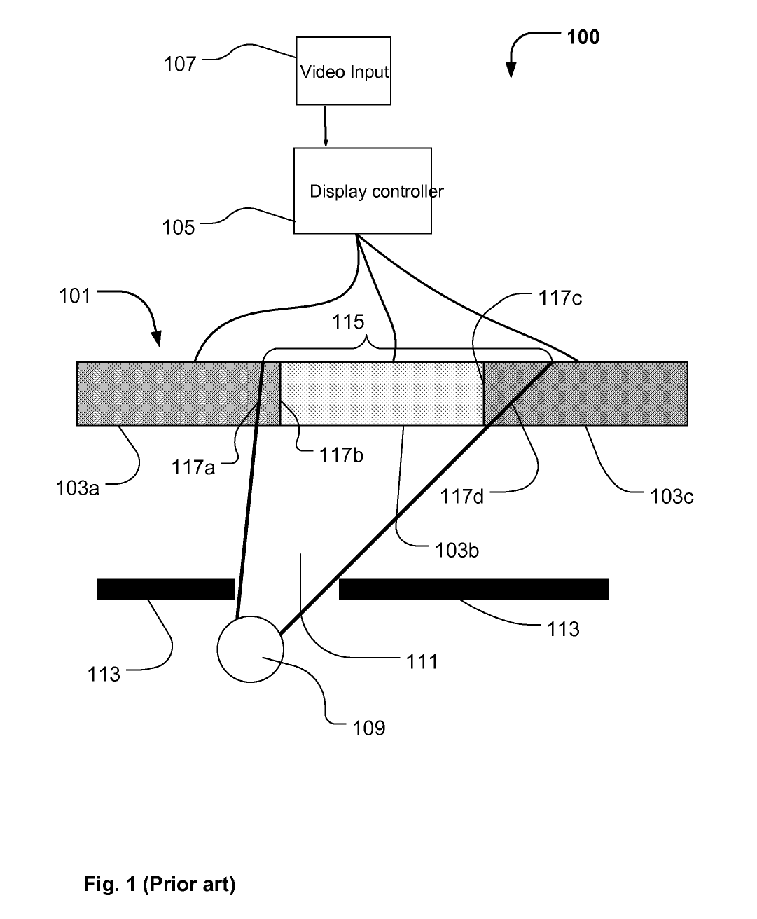

FIG. 1 illustrates an electronic display system 100 embodied as a perimeter board system. The display system comprises a display 101 comprising a number of display panels 103a, 103b and 103c. A display controller 105 is communicatively coupled to the display panels and a content provider 107 is communicatively coupled to display controller 105 and the display controller 105 receives content to be displayed at the display 101 form the content provider. The display controller 105 distributes and sends the content to the display panels 103a, 103b, 103c in a predetermined manner whereby the content are shown at the display.

The content provider 107 can be embodied as a media server that sends video data to the input of the display controller. As the resolution of a perimeter board is not as high as nowadays video resolutions, more perimeter board images can be stacked in one regular video image. The display controller 105 is responsible for un-stacking the input images. After the input is divided in regions corresponding with the display panels, the display controller sends the corresponding image region to the designated display panel 103a, 103b and 103c.

FIG. 1 illustrates a situation where the sun 109 shines sunlight 111 onto a part of the display 101 as a sun blocker 113 for instance the stadium tribune blocks a part of the sun light. The result is that the display panel in region 115 will have a lower contrast and thus a reduced visibility. The prior art systems tries to compensate this by increasing the brightness of display panel 103b as this panel is completely covered by the sunlight 111. The brightness of display panels 103a and 103c is not increased as most of these display panels are not covered by sunlight. The consequence is that hard edges 117 appear of the display and the display does thus not appear as a seamless display.

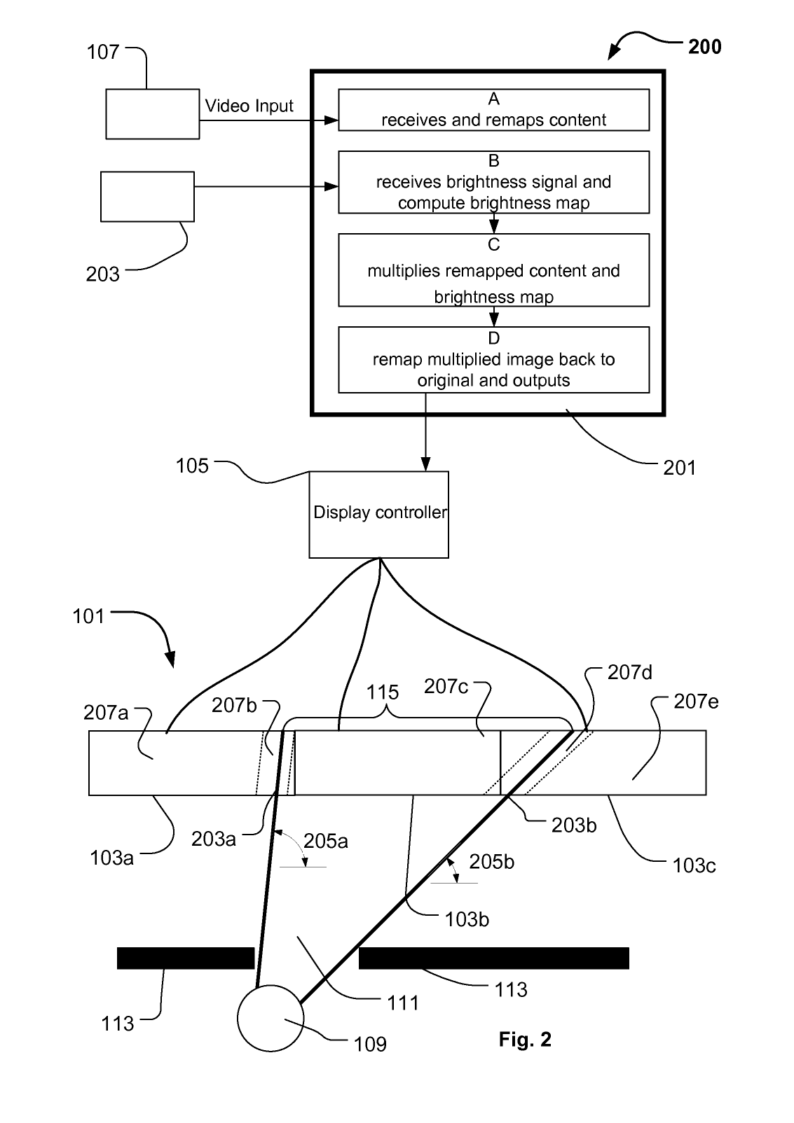

FIG. 2 illustrates a perimeter board system according to the present invention and is designed to deal with these problems. The electronic display system 200 comprises in addition the prior-art display system of FIG. 1 a brightness controller 201 communicatively coupled to the display controller 105 and the content provider 107. The brightness controller 201 is adapted to receive the content from the content provider, to adjust at least the brightness and/or the contrast of at least a part of the received content based on a brightness signal 203 and send the adjusted content to the display controller.

The steps performed by the brightness controller 201 are illustrated inside the box illustrating the brightness controller. In step A the brightness controller receives and remaps the input to a virtual space that represents the entire screen the content. In step B the brightness controller receives the brightness signal and computes a brightness map. In step C the brightness controller multiplies the remapped content with the brightness map. In step D the brightness controller remaps this resulting image to the original space and sends it to the display controller.

The brightness mask is determined on basis the brightness signal which is indicative of at least one brightness parameters. The brightness parameters can for instance be the start 203a and end position 203b of the display where sunlight hits the display, the slope 205a and 205b of the incoming sunlight in relation to the display, intensity of the incoming sunlight light, a brightness value of the ambient light inside sunlight, a brightness value of ambient light outside the sunlight etc. These values can for instance be obtained through a user communicating with the brightness controller 201 through a user interface and/or through a number of sensors (e.g. cameras, sunlight detectors). The brightness mask comprises a number of brightness regions 207a-207e which is determined on basis of the brightness parameters. The brightness mask regions are illustrated on the display 101 and are separated by dotted lines. Brightness region 207a and 207e is obtained at the original brightness as these regions of the display 101 are positioned in the shade. The brightness of region 207c is increased as this region is positioned in the sun. Brightness regions 207b and 207d are defined as intermediate regions where the brightness gradually changes across the region such that the brightness of the boundaries is equal to the brightness of the neighboring region. This can for instance be achieved by a interpolation between the two brightness levels of the neighboring regions. The intermediate regions are positioned such that areas where sunlight and shade meets are covered by intermediate regions.

A seamless screen can be made out of several perimeter boards with brightness compensation to overcome the loss of contrast caused by direct sunlight. Only the start and end position of the interval need to follow the movements of the sun.

Since the brightness controller is placed between the output of a content provider e.g. a media server and the input of the display controller, the brightness controller 201 is responsible to do the un-stacking of the input image. Therefore, the brightness controller 201 knows how the mapping of the perimeter boards to the input video image is done. For instance a user can manually identify the mapping and for each perimeter board select a region that corresponds with it. This can be done in the setup phase, it can be saved and only needs to be done once.

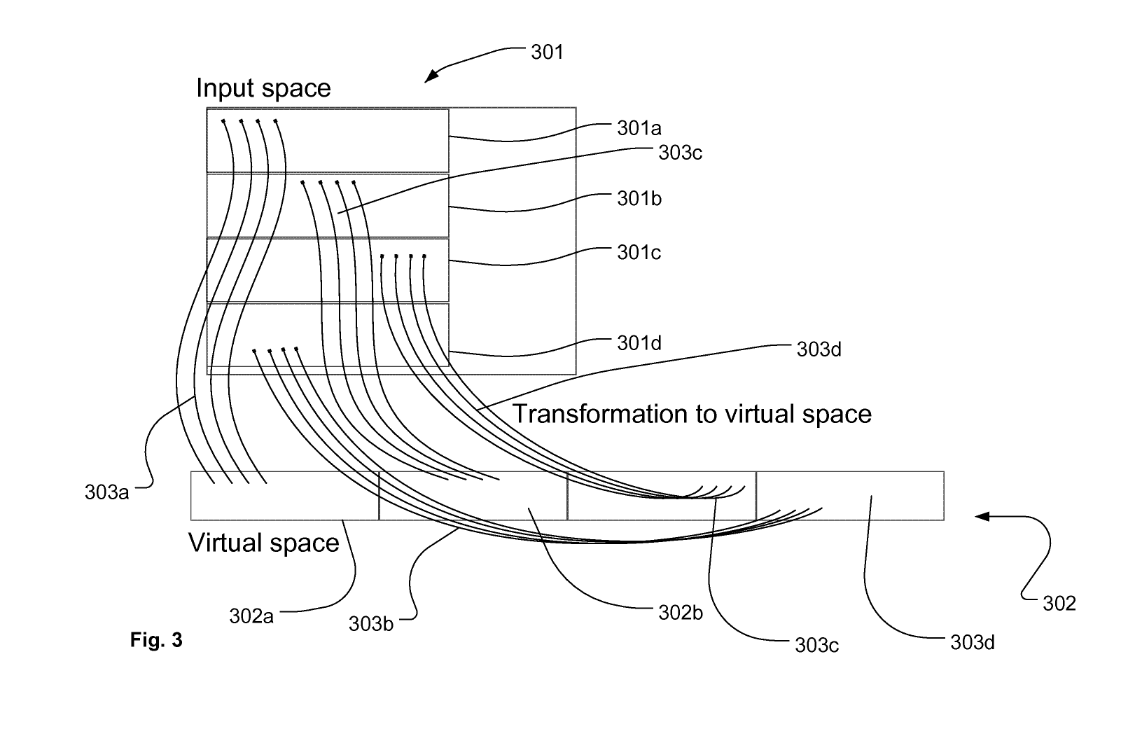

Once the mapping is known, a transformation, (noted T in the following text for simplicity), is made to a new virtual space (noted S in the following text for simplicity. T provides a mapping of each pixel on the input image to a virtual output image. FIG. 3 illustrates a transformation where the original pixel space 301 is transformed to a new virtual space 302. The arrows 303a-303d indicates how the sections 301a-301d of the original pixel space are transformed into a sections 302a-302b of the new virtual space 302. It can be seen that the sections of the original pixel space are positioned above each other where as they in the new space are positioned in row. This new space S is the virtual representation of the setup of the perimeter boards in the real world situation. For example, in the situation of a sports event, all perimeter boards are place placed horizontally next to each other. In this case there will be a transformation that transforms all pixels of the input image to one horizontally stretched output image. Since the space S is dependent on the real world setup, a different transformation may be needed for a different setup.

When the transformation, T, to the virtual space, S, is known, the brightness mask, (noted B in the following text for simplicity), is computed. B is represented in space S and is computed at a pixel exact basis. B contains different brightness values at different pixels. In theory each pixel is independently controllable. However, this is not very user-friendly. It is not necessary to control each pixel independently. It is more useful make a simplified model that is applicable in many situations.

We now briefly describe a model to compute and control the brightness map, B, using only several parameters. We use the hypothesis that in real world situations only one part of the screen will be in direct sun light. This is an acceptable hypothesis since there is only one sun, and for regular outdoor venues (e.g. sports stadium) there will be not many independent sun blockers (e.g. trees). The two most important parameters ([start, end]) define a horizontal interval, (noted I in the following text for simplicity), in the virtual space. Interval I represents the presence or absence of direct sunlight in the real world set up. The brightness inside I can be adjusted independently of the brightness outside I. To increase the correspondence with the real world situation, further fine-tuning of interval I can be done by adjusting the angles of the slopes of the vertical borders of the interval. To overcome hard edges at the start or end of the interval, the two brightness levels at the borders of the interval are interpolated. For a seamless screen it is important to be able to control the smoothness of this interpolation. This model can be easily extended to more horizontal intervals.

However, practice showed us that usually one interval will do.

In the next step the computed brightness map, B, will be pixel wise multiplied with the transformed input image:

O=B*.T(Input Image)

Finally, as the resulting image is still in the virtual space S an inverse transformation, T⁻¹, is needed to get the result in the original space:

Final image=T⁻¹(O)

This final image is send to the input of the perimeter board controller. Summarized algorithm:
1. Setup phase:

Define mapping from input image to individual perimeter boards
2. Run phase (for each input image):

Transform to new virtual space that resembles to the real setup of the perimeter boards.

Compute brightness mask in this space.

Do a pixel wise multiplication of the brightness mask with the transformed input image.

Inverse transform resulting image to the input space.

Send result to the input of the perimeter board controller.

The most important benefit is that an exact compensation for direct sunlight can be made. Thanks to the described model this can be done without disturbing artifacts. The transformation of the input image to a more relevant space (real world setup), together with the simple model to virtually reconstruct the position of the sunlight on the perimeter boards, makes the sun shader intuitive, easy controllable and flexible. The only thing the user needs to do is, locate the interval, in the virtual space, where the sun light is present and adjust the brightness values inside and outside this interval according to the intensity of the sunlight. Because the virtual space is constructed to resemble to the real world setup, this is very straight forward. Once the initial settings are made, the operator only needs to follow the movements of the sun by adjusting the start and end positions of the interval where the sun light is present. As the presented algorithm is highly optimized for graphical hardware the sun shader can operate in real-time modus.

Prior art techniques to compensate for the difference in contrast caused by the difference in light intensity on parts of the perimeter boards that are in direct sun light and parts of the perimeter boards that are in the shadow, are limited in granularity to the brightness correction of each perimeter board individually. They can compensate for the difference in contrast but result in visible artifacts on places where the brightness correction is applied. The visible artifacts include:
hard edges between perimeter boards that have different brightness levels
and hard edges caused by the mismatch between the casted shape on the perimeter boards of the sun light and the brightness controlled shape. These mismatches are the result of a too coarse brightness correction granulation (i.e. one perimeter board). As television cameras are very sensitive to these artifacts, these prior art sun shading techniques are not applicable for broadcast television recordings.

Our technique, on the other hand, has a pixel precise brightness correction granulation, combined with an intuitive model to reconstruct the presence of sunlight on the perimeter boards. It can therefore adjust its brightness levels optimally to shape of the sun light casted on the perimeter boards. Common artifacts of the prior art techniques, like hard edges, are avoided by:
the use of gradual interpolation between different brightness values
and the pixel precise modeling of the shape of the sun light casted on the perimeter boards.

As the sun moves during the day, the casted presence or absence of direct sun light will move accordingly. In order to be able to compensate these movements, the sun shader is real-time adjustable.

Since our techniques results in a seamless screen with minimal artifacts and brightness compensation where needed, it is suited for broadcast television recordings.

1. An electronic display system comprising:
a display comprising a number of display panels;
at display controller communicatively coupled to said display panels;
a content provider communicatively coupled to said display controller;
where said display controller receives content to be displayed at said display, said display controller distributes and sends said content to said display panels in a predetermined manner wherein said electronic display system comprises a brightness controller communicatively coupled to said display controller and said content provider and in that said brightness controller is adapted to:
receive said content from said content provider,
adjust the brightness at least a part of said content based on a brightness signal,
send the adjusted content to said display controller.

2. An electronic display system according to claim 1 wherein said brightness controller is adapted to adjust the contrast of at least a part of said content based on said brightness signal,

3. An electronic display system according to claim 1 wherein said brightness signal is indicative of at least one brightness parameter.

4. An electronic display system according to claim 1 wherein said brightness controller determines at least one brightness mask based on said brightness signal and adjust the brightness or the contrast of said content based on said brightness mask.

5. An electronic display system according to claim 4 wherein said brightness mask comprises at least one intermediate region where the brightness gradually changes across the region such that the brightness of the boundaries is equal to the brightness of the neighboring region.

6. An electronic display system according to claim 2 wherein said brightness parameters is indicative of at least one ambient light at least one position of said display.

7. An electronic display system according to claim 2 wherein said brightness parameters is indicative of a first region of said display where said first region is hit by sunlight.

8. An method of displaying content on a display comprising a number of display panels, said method comprises the steps of:
providing content to be displayed by said display;
distributing said content to said display panels;
wherein said method further comprises the step of:
adjusting the brightness of at least a part of said content based on a brightness signal.

9. A method according to claim 8 wherein said method further comprises the step of:
Adjusting the contrast of at least a part of said content based on said brightness signal.

10. An method according to claim 8 wherein said brightness signal is indicative of at least one brightness parameter.

11. An method according to claim 8 wherein said step of adjusting at least the brightness or the contrast of at least a part of said content based on a brightness signal comprises the step of:
determining at least one brightness mask based on said at least one brightness signal and combining said content with said brightness mask.

12. An method according to claim 8 wherein said brightness mask comprises at least one intermediate region where the brightness gradually changes across the region such that the brightness of the boundaries is equal to the brightness of the neighboring region.

13. An method according to claim 8 wherein said brightness parameters is indicative of at least the ambient light at least one position of said display.

14. An method according to claim 8 wherein said brightness parameters is indicative of a first region of said display where said first region is hit by sunlight.
